(19) United States
(12) Patent Application Publication
(10) Pub. No.: US 2015/0231548 A1
(43) Pub. Date: Aug. 20, 2015

(54) AIR CLEANING DEVICE

(71) Applicant: CHEN-HSIN LIN, NEW TAIPEI CITY (TW)

(72) Inventor: CHEN-HSIN LIN, NEW TAIPEI CITY (TW)

(21) Appl. No.: 14/598,442

(22) Filed: Jan. 16, 2015

(30) Foreign Application Priority Data
Feb. 19, 2014 (TW) 103202820

(51) Int. Cl. B01D 50/00; A01G 9/20; A01G 13/08; B01D 45/08; B01D 47/02

(52) U.S. Cl. CPC B01D 50/004; B01D 45/08; B01D 47/02; A01G 13/08; A01G 9/20

(57) ABSTRACT

An air cleaning device includes a body, a deflector, a filter material and a fan module. The body includes a first opening, a second opening, and at least a first accommodating tank. The deflector is disposed above the first accommodating tank and divides an interior of the body into an air inlet portion and an air outlet portion, wherein the air inlet portion communicates with the first opening and the air outlet portion communicates with the second opening. The filter material is filled in the first accommodating tank. The fan module draws external air through the air inlet portion to pass through the filter material to enter the air outlet portion.

### FIELD OF THE INVENTION

The present invention relates to a cleaning device, and in particular to an air cleaning device.

### BACKGROUND OF THE INVENTION

The prosperous development and progress of industrial and commercial activities cause a great consumption of energy, leading to global warming and desertification, and consequently, the atmosphere contains and carries various suspending particles and toxicant substances. People working or living in the environments of office and household unconsciously take in and accumulate in their bodies all sorts of unhealthy factors from air and diets, such allergy and cancer, which badly affect living quality.

To be healthy mentally and physically is a goal pursued by everyone. Exercise is one way to achieve such a goal. However, in this modern commercialized world, sufficient time and a proper environment for sustainably doing exercise are not affordable to everyone. Medicine and health food are another promising way. However, metabolizing medicine or health food may also be a burden to human body.

Thus, the present invention aims to provide a solution for maintaining normal functioning of human body and thus enhancing living quality by applying a simple way, based on the essential factors of human lives, such as sunlight, air, and water, to eliminate all sorts of factors that are potentially detrimental to human body healthy.

### SUMMARY OF THE INVENTION

The primary object of the present invention is to provides an air cleaning device, which comprises a body, a deflector, a filter material, and a fan module. The body comprises at least one first opening, at least one second opening, and at least one first accommodating tank. The deflector is arranged above the first accommodating tank and divides an interior of the body into an air inlet portion and an air outlet portion, wherein the air inlet portion is in communication with the first opening and the air outlet portion is in communication with the second opening. The filter material is disposed in the first accommodating tank. The fan module is arranged internally or externally of the body to draw external air through the first opening into the air inlet portion to pass the filter material or to be reflected by a surface of the filter material to enter the air outlet portion.

The present invention provides an air cleaning device, which comprises a fan module and a deflector for drawing in and guiding external air or alternatively, the fan module is installed in a ventilation environment to allow external air to freely move through the air inlet portion of the body to contact the filter material contained in the first accommodating tank so that the filter material may absorb suspending particles and toxicant substances carried by the external air. The cleaned air then passes through the air outlet portion of the body to discharge into an indoor space. Thus, the air cleaning device of the present invention allows for eliminating all sorts of factors of the atmosphere that are potentially detrimental to human body health through a simple way so a to maintain normal function of human body. Further, the air cleaning device of the present invention can be combined with green plants, a light source module, and a light transmittable surface panel to further improve quality of living.

### BRIEF DESCRIPTION OF THE DRAWINGS

The present invention will be apparent to those skilled in the art by reading the following description of preferred embodiments thereof with reference to the drawings, in which:

FIG. 1 is a perspective view showing a first embodiment according to the present invention;

FIG. 2 is a cross-sectional view taken along line A-A′ of FIG. 1;

FIG. 3 is a cross-sectional view showing a second embodiment according to the present invention;

FIG. 4 is a cross-sectional view showing a third embodiment according to the present invention; and

FIG. 5 is a perspective view showing the third embodiment according to the present invention.

### DETAILED DESCRIPTION OF THE PREFERRED EMBODIMENTS

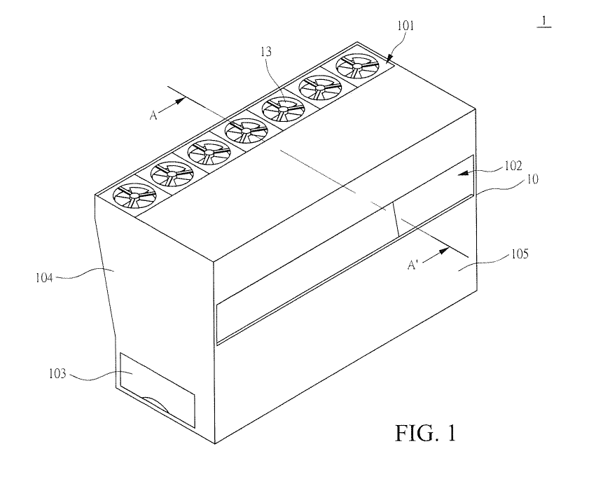

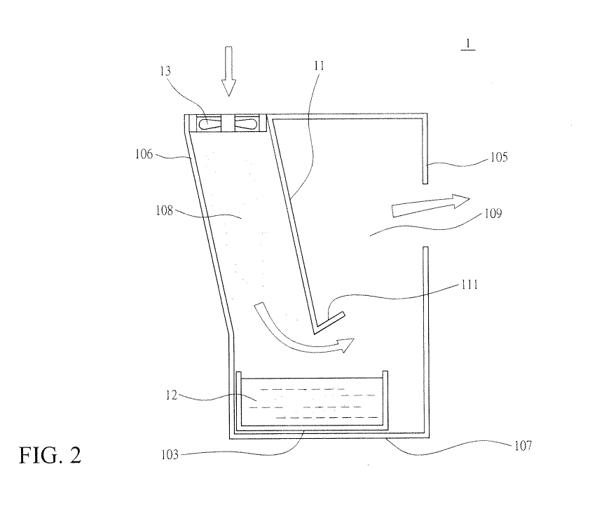

FIG. 1 depicts a perspective view of a first embodiment according to the present invention and FIG. 2 depicts a cross-sectional view taken along line A-A′ of FIG. 1. Referring to FIG. 1, the present invention provides an air cleaning device 1, which comprises a body 10, a deflector 11, a filter material 12, and a fan module 13. The body 10 comprises a first opening 101 and a first accommodating tank 103. Specifically, the body 10 is roughly in the form of a box, which generally composed of a bottom board 107, a first side board 104 and a second side board (not shown) that are opposite to each other, and a surface panel 105 and a back panel 106 that are opposite to each other and the material can be steel or resin materials, for which the present invention sets up no limitations. The deflector 11 is connected to both the first side board 104 and the second side board in such a way that the first opening 101 is formed between the deflector 11 and the back panel 106 and a second opening 102 is formed between the deflector 11 and the surface panel. The first accommodating tank 103 is arranged as a drawer that is withdrawable through the first side board 104 for accommodating therein the filter material 12. The fan module 13 is arranged internally or externally of the body to draw external air through the first opening 101 into the body 10.

To more clearly describe the interior structure of the embodiment of the present invention illustrated in FIG. 1, additional reference will be made to FIG. 2, in combination with FIG. 1, where the deflector 11 is shown arranged above the first accommodating tank 103 and slants generally from the first opening 101 toward the second opening 102 so as to divide the interior of the body into an air inlet portion 108 and an air outlet portion 109, wherein the air inlet portion 108 is in communication with the first opening 101 and the air outlet portion 109 is in communication with the second opening 109. The filter material 12 is filled in the first accommodating tank 103. The filter material 12 can be water or extract aqueous solution added with various natural substances, such as flower/herb essential oil and phytoncide oil, having a pH value in the range of neutral or weak basicity (pH7-9) for diluting or neutralizing acidic suspending substance contained in air. When the fan module 13 draws in external air through the first opening 101 into the air inlet portion 108 of the body 10, the deflector 11 guides the external air that carries suspending particles and toxicant substances to flow toward the surface of the filter material 12 to be absorbed thereby (wherein, in the drawings, the hollow arrow indicates the flowing direction of air, while the multiple dots indicate the suspending particles and the toxicant substances entraining the external air). In the instant embodiment, the deflector 11 comprises an extension section 111, which has a substantially V-shaped configuration. The external air, after being guided toward the filter material 12, is subjected to filtering thereby or being reflected by the surface of the filter material 12 to become purified clean air that moves along the extension section 111 into the air outlet portion 109 to be released through the second opening 102.

The air cleaning device 1 of the present invention uses the arrangement of the fan module 13 and the deflector 11 to guide external air toward the first accommodating tank 103 to be purified and cleaned by the filter material 12. The first accommodating tank 103 is of a drawer like design, so that after the filter material 12 has been used for a predetermined period of time, such as exceeding several hours or one day, the first accommodating tank 103 can be easily removed from the body 10 for replacement of the filter material 12. This device may include an electric pump or other automatic circulation system to help maintain the water clean and fresh. Further, it is noted that the surface panel 105 can be a displaying panel that is light non-transmittable or light transmittable. When the surface panel 105 is connected to an external electrical signal, the surface panel may display a static or even dynamic image (such as scenery picture) to improve fun of living.

Besides cleaning air, the air cleaning device of the present invention may further include a light source module and green plants to achieve effects of oxygen supply, disinfection, and sterilization.

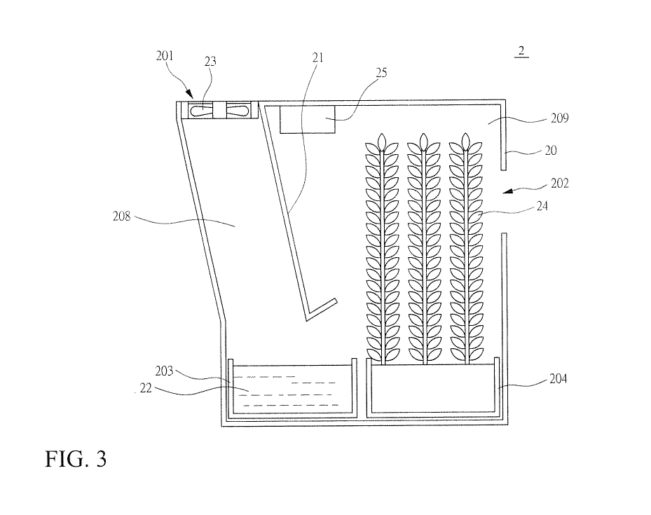

FIG. 3 depicts a cross-sectional view of a second embodiment of the present invention. Referring to FIG. 3, in the instant embodiment, in addition to the body 20, the deflector 21, the filter material 22, and the fan module 23, the air cleaning device 2 also comprises green plants 24 and a light source module 25, wherein the body 20 comprises the first opening 201, the second opening 202, the air inlet portion 208, the air outlet portion 209, the first accommodating tank 203, and a second accommodating tank 204. The green plants 24 are arranged in the second accommodating tank 204 of the body 20. The light source module 25 is mounted on the deflector 21 to irradiate the green plants 24 for generating oxygen through photosynthesis.

In detail, the light source module 25 comprises at least one first light source and at least one second light source, wherein the first light source supplies light having a wavelength less than 500 nanometers and the second light source supplies light having a wavelength greater than 500 nanometers, such as a light-emitting diode (LED) combining wavelengths of blue, green, and red light or tri-wavelength plant light in combination with ultraviolet disinfection light. The light source module 25 can supply light of full wave band for making the green plants 24 proceed with photosynthesis to generate oxygen and also, the first light source may generate ultraviolet light for sterilization and disinfection. Thus, beside the function of air purification of the air cleaning device 1, the air cleaning device 2 further provides the function of oxygen supply, sterilization, and disinfection to further improve quality of air in the living environment.

It is noted that the air cleaning device of the present invention is not constrained by size or environment of installation. For example, it can be structured as a stand-alone device for indoor use or it can be combined with a window of a building and green plants to be arranged on a balcony or terrace for supplying clean, oxygen-rich, and non-toxicant air to a household or office environment. As such, when the air cleaning device of the present invention is used in such environments, the fan module 13 may be removed from the first opening 101, 201 based on the intensity of wind on the surroundings and the fan module 13 can be arranged outside the body or in the second opening 102, 202 so that external air that carries suspending particles and toxicant substances can be driven toward the filter material 12, 22, 32.

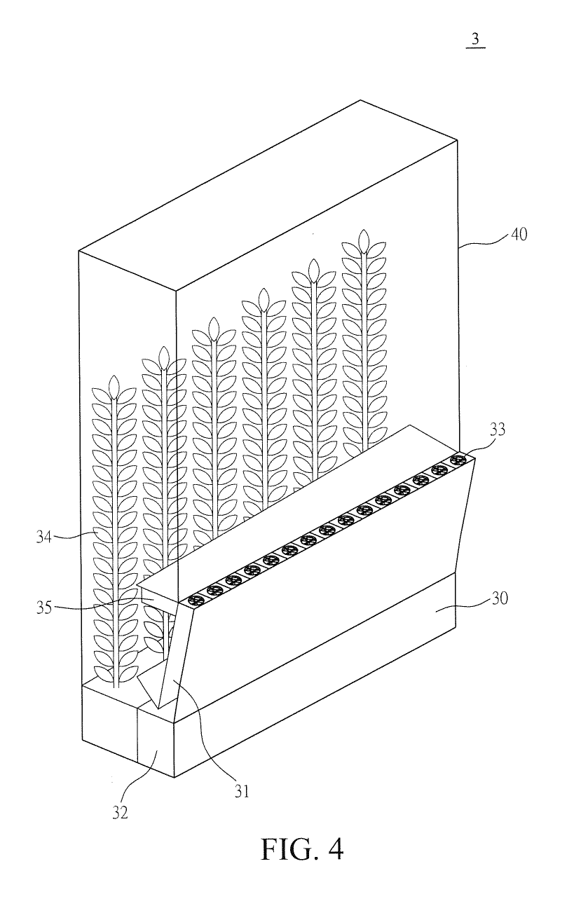

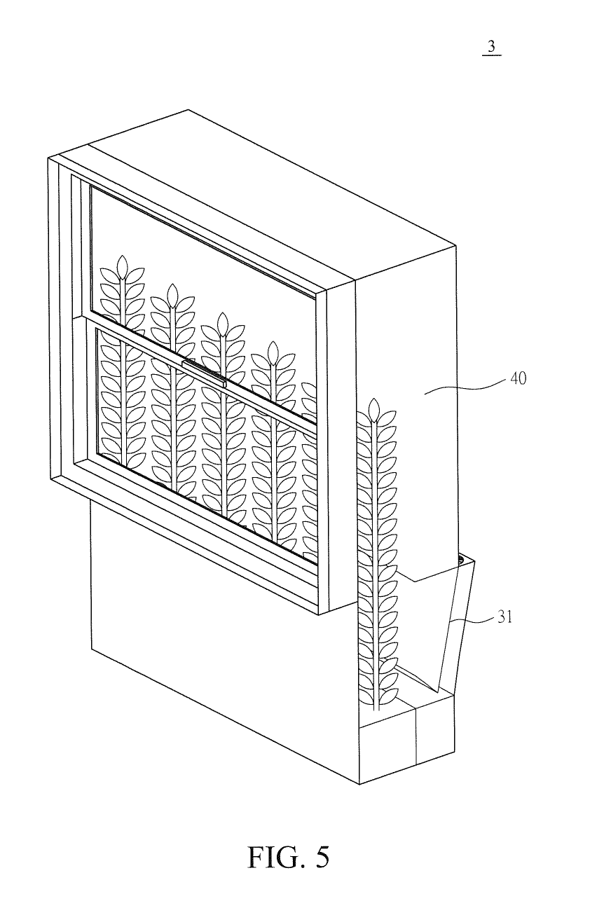

FIG. 4 depicts a cross-sectional view of a third embodiment of the present invention and FIG. 5 is a perspective view of the third embodiment. Referring to FIGS. 4 and 5, the air cleaning device 3 is mounted on a window 40 and comprises the body 30, the deflector 31, the filter material 32, the fan module 33, the green plants 34, and the light source module 35. The functions of air purification, oxygen supply, and disinfection of the air cleaning device 3 can be referred to the first and second embodiments and repeated description will be omitted here.

In summary, the present invention provides an air cleaning device, which comprises a fan module and a deflector for drawing in and guiding external air to allow the external air to move through the air inlet portion of the body to contact the filter material contained in the first accommodating tank so that the filter material may absorb suspending particles and toxicant substances carried by the external air. The cleaned air then passes through the air outlet portion of the body to discharge into an indoor space. Thus, the air cleaning device of the present invention allows for eliminating all sorts of factors of the atmosphere that are potentially detrimental to human body health through a simple way so a to maintain normal function of human body. Further, the air cleaning device of the present invention can be combined with green plants, a light source module, and a light transmittable displaying surface panel to further improve quality of living.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An air cleaning device, comprising:
a body, which comprises at least one first opening, at least one second opening, and at least one first accommodating tank;
a deflector, which is arranged above the at least one first accommodating tank and divides an interior of the body into an air inlet portion and an air outlet portion, wherein the air inlet portion is equipped with the at least one first opening and the air outlet portion is equipped with the at least one second opening;
at least one filter material, which is disposed in the at least one first accommodating tank; and
at least one fan module, which is arranged internally or externally of the body to draw external air through the at least one first opening into the air inlet portion to pass the at least one filter material or to be reflected by a surface of the at least one filter material to enter the air outlet portion.

2. The air cleaning device as claimed in claim 1, wherein the body comprises:
a bottom board;
a first side board and a second side board, which are arranged on the bottom board and are opposite to each other, the deflector being connected to the first side board and the second side board; and
a back panel and a surface panel, which are arranged among the first side board, the second side board, and the bottom board and are opposite to each other, the at least one first opening being formed between the back panel and the deflector, the at least one second opening being formed between the surface panel and the deflector.

3. The air cleaning device as claimed in claim 1, wherein the body further comprises at least one second accommodating tank, which is arranged in the air outlet portion.

4. The air cleaning device as claimed in claim 3 further comprising:
at least one green plant, which is arranged in the body; and
at least one light source module, which irradiates the green plant.

5. The air cleaning device as claimed in claim 4, wherein the at least one light source module comprises at least one first light source and at least one second light source, the at least one first light source supplying light including the wavelength less than 500 nanometers, the at least one second light source supplying light including the wavelength longer than 500 nanometers.
